(19) United States
(12) Patent Application Publication
(10) Pub. No.: US 2004/0240802 A1
(43) Pub. Date: Dec. 2, 2004

(54) Laser output device, laser output method, and video display apparatus

(75) Inventor: Masaki Tsuchida, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/814,297

(22) Filed: Apr. 1, 2004

(30) Foreign Application Priority Data
May 30, 2003 (JP) 2003-155465

(51) Int. Cl. G02B 6/36

(52) U.S. Cl. 385/93

(57) ABSTRACT

The present invention relates to a laser output device in which laser light of a specific wavelength transmitted in an optical fiber is returned to the optical fiber by means of a mirror so that high output laser light can be emitted. The device is equipped with an optical fiber, a mirror configured to reflect light of the specific wavelength transmitting in the optical fiber to return the light to the optical fiber, and a support portion configured to support an end surface of the optical fiber and the mirror in a state in which they are pressed against each other.

### CROSS-REFERENCE TO RELATED APPLICATIONS

This application is based upon and claims the benefit of priority from prior Japanese Patent Application No. 2003-155465, filed May 30, 2003, the entire contents of which are incorporated herein by reference.

### BACKGROUND OF THE INVENTION

1. Field of the Invention

The present invention relates to a laser output device and laser output method by which high output laser light can be emitted and in particular to an improvement obtained by permitting laser light with a specified wavelength which is transmitted in an optical fiber to return to the optical fiber by means of a mirror. Further, the present invention relates to a projection type video display apparatus in which the laser output device is employed as a light source.

2. Description of the Related Art

As is commonly known, in the field of optical communications, various techniques have been developed with respect to means for optically connecting an optical fiber for optical transmission and an optical transmitting module efficiently, means for optically connecting optical fibers efficiently, and the like, and optical connection means of various configurations have been considered.

For example, Jpn. Pat. Appln. KOKAI Publication No. 11-258457 discloses a configuration in which two ferules in each of which an optical fiber is fixed are connected such that the optical inlet and outlet thereof are pressed against each other by means of a spring so as to allow the ferules to be in intimate contact with each other, thereby to reduce the optical transmission loss.

Meanwhile, in recent years, in order to employ a semiconductor laser element as a light source in a projection type video display apparatus such as, for example, a liquid crystal projector or the like, a new system has been developed. In this type of video display apparatus, laser light emitted from the semiconductor laser element is used for spatial modulation by a video signal via a fiber laser device.

In this fiber laser device, laser light emitted from the semiconductor laser element is permitted to enter an optical fiber to which a laser active material is added in the core thereof so that a specified wavelength laser light is returned in the optical fiber by means of a mirror so as to be resonated, whereby high output laser light can be obtained.

Thus, with respect to a fiber laser device in which an optical fiber having double clad as described above is employed also, various techniques have been developed extensively. For example, in Jpn. Pat. Appln. KOKAI Publication No. 11-121836 discloses a technique related to a multilayer mirror and a double clad fiber for producing high output laser light.

However, this Jpn. Pat. Appln. KOKAI Publication No. 11-121836, with respect to the technique by which a fiber and a multilayer mirror are optically connected, does not describe a technique by which optical transmission loss between connections is reduced as proposed by the Jpn. Pat. Appln. KOKAI Publication No. 11-258457 of the technique by which optical fibers are optically connected.

Meanwhile, a technique by which laser light is resonated employing a mirror in an optical fiber to which a laser active material is added is disclosed in Jpn. Pat. Appln. KOKAI Publication Nos. 10-22560, 6-37371, and 8-97492. However, the three publications also do not describe a technique in which an optical fiber and a mirror are optically connected efficiently to reduce the transmission loss.

### BRIEF SUMMARY OF THE INVENTION

According to one aspect of the present invention, there is provided a laser output device comprising: an optical fiber; a mirror configured to reflect light of a specific wavelength transmitting in the optical fiber to return the light to the optical fiber; and a support portion configured to support an end surface of the optical fiber and the mirror in a state in which they are pressed against each other.

According to one aspect of the present invention, there is provided a laser output method comprising: supporting an end surface of an optical fiber and a mirror which reflects light of a specific wavelength transmitting in the optical fiber to return the light to the optical fiber in a state in which the end surface of the optical fiber and the mirror are pressed against each other.

According to one aspect of the present invention, there is provided a video display apparatus comprising: a fiber laser device configured to support an end surface of an optical fiber and a mirror which reflects light of a specific wavelength transmitting in the optical fiber to return the light to the optical fiber in a state in which the end surface of the optical fiber and the mirror are pressed against each other; a modulation portion configured to perform spatial modulation for the light to be outputted from the fiber laser device based on a video signal; and a display portion configured to project and display light output obtained from the modulation section on a screen.

### BRIEF DESCRIPTION OF THE SEVERAL VIEWS OF THE DRAWING

FIG. 1 shows a first embodiment of the present invention and is a diagram shown to describe a liquid crystal projection TV receiver.

FIG. 2 is a diagram shown to describe a configuration of a fiber laser device in the first embodiment.

FIG. 3 is a diagram shown to describe a detailed configuration of a main portion of the fiber laser device in the first embodiment.

FIG. 4 is a perspective view shown to describe a detailed shape of a fixture in the first embodiment.

FIG. 5 shows a second embodiment of the present invention and is a diagram shown to describe a detailed configuration of a main portion of a fiber laser device.

FIG. 6 shows a third embodiment of the present invention and is a diagram shown to describe a detailed configuration of a main portion of a fiber laser device.

FIG. 7 shows a fourth embodiment of the present invention and is a diagram shown to describe a detailed configuration of a main portion of a fiber laser device.

FIG. 8 shows a fifth embodiment of the present invention and is a diagram shown to describe a detailed configuration of a main portion of a fiber laser device.

FIG. 9 is a diagram shown to describe another example of a liquid crystal projection TV receiver in which the fiber laser device shown in the respective first to fifth embodiments is employed as a light source.

### DETAILED DESCRIPTION OF THE INVENTION

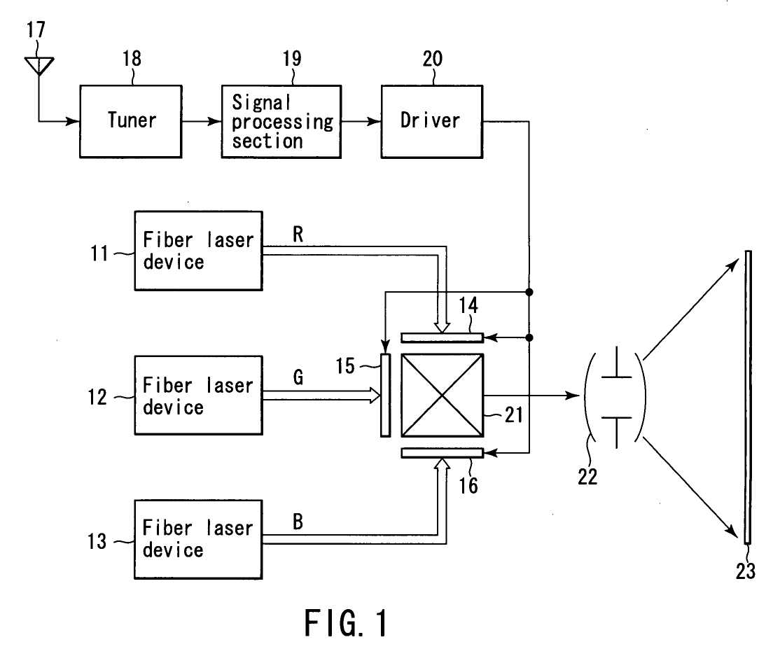

A first embodiment of the present invention will be described in detail below with reference to the drawings. FIG. 1 shows a liquid crystal projection TV (television) receiver as a projection type video display apparatus described in the first embodiment.

That is, in FIG. 1, respective reference numerals 11, 12, 13 represent fiber laser devices. Laser lights of R (red), G (green), and B (blue) are emitted from these fiber laser devices 11, 12, 13.

Laser lights of R, G, and B emitted from the respective fiber laser devices 11, 12, 13 are incident onto liquid crystal panels 14, 15, 16 which are disposed corresponding to respective lights and which constitute spatial modulation means.

A television broadcast signal received at an antenna 17 is tuned in to a channel in a tuner 18 and is demodulated in a signal processing section 19 to become a video signal. This video signal is then inputted to the respective liquid crystal panels 14, 15, 16 via a driver 20.

Thus, the laser lights of R, G, and B incident onto the respective liquid crystal panels 14, 15, 16 are given spatial modulation by the video signal, respectively, and are synthesized by synthesis means such as a dichroic prism 21 or the like.

This synthesized light is enlarged and projected on a screen 23 via a projection lens 22 so that images of a television broadcast are displayed.

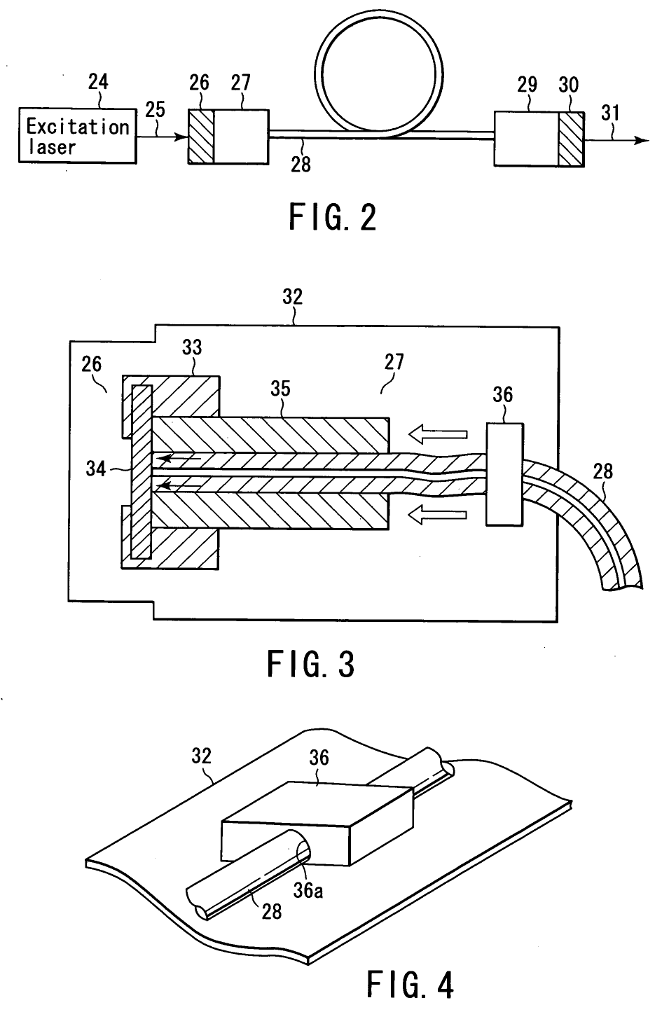

FIG. 2 shows the detail of the fiber laser device 11. The fiber laser device shown in this FIG. 2 is an upconversion fiber laser device. Explanation for the other fiber laser devices 12, 13 will be omitted since only the colors of the emitted laser lights are different and the fiber laser devices 12, 13 have structures similar to that of the fiber laser device 11.

That is, excitation light 25 emitted from an excitation laser 24 is incident onto a mirror portion 26 which reflects light of a specific wavelength. In this case, the excitation light 25 can pass through the mirror portion 26 completely.

The excitation light 25 which has passed through the mirror portion 26 is incident onto an optical fiber 28 whose one end is supported on a fiber support portion 27. A rare earth element is added to the core of the optical fiber 28 as a laser activation material.

The excitation light 25 incident onto the optical fiber 28 is absorbed in the rare earth element so that light of a specified wavelength is emitted.

The other end of the optical fiber 28 is supported on a fiber support portion 29 so as to be opposed to a mirror portion 30. Light of a specified wavelength is resonated by means of this mirror portion 30 to be outputted to the liquid crystal panel 14 as laser light 31.

Here, by permitting the mirror portion 30 that is in the light output side to have a property in which the excitation light is reflected, utilization efficiency of the excitation light can be enhanced.

In this case, the resonance condition changes due to the connection condition between the mirror portions 26, 30 and the optical fiber 28, and there is some possibility that the produced laser output drastically fluctuates.

Thus, the optical fiber 28 and the mirror portion 26, 30 are brought to a state in which they are pressed against each other by a predetermined force by the above-mentioned fiber support portions 27, 29, so that a stable laser output whose optical transmission loss is small is obtained.

FIG. 3 shows a detailed configuration of the mirror portion 26 and the fiber support portion 27. Explanation of the mirror portion 30 and the fiber support portion 29 will be omitted since they have a similar configuration.

That is, the mirror portion 26 is composed of a mirror support portion 33 supported on a base 32 and a mirror 34 supported on this mirror support portion 33. This mirror 34 is, for example, one obtained by depositing a multilayer film on a thin flat glass and is arranged such that the deposition surface faces the optical fiber 28 side.

The fiber support portion 27 is composed of a cylindrical ferule 35 into which the optical fiber 28 is inserted loosely and a fixture 36 supporting the optical fiber 28 extended from this ferule 35 on the base 32.

The ferule 35 is fixedly fitted into the mirror support portion 33 on the deposition surface of the mirror 34 so as to be perpendicular to the mirror 34. Under these circumstances, it is desired that there is no space between the mirror support portion 33 and the ferule 35. Thus, when coming into contact with the mirror 34, an end surface of the optical fiber 28 can be pressed against the mirror 34 perpendicularly. The optical fiber 28 is cut by means of a fiber cutter or the like such that the end surface thereof is flat.

When the optical fiber 28 is inserted into the ferule 35 so that the optical fiber 28 comes into contact with the mirror 34, the optical fiber 28 is further pushed to such an extent that the optical fiber 28 is not broken so as to give the optical fiber 28 tension for returning to its original state. The tension is permitted to remain as it is, and the optical fiber 28 is fixed on the base 32 by means of the fixture 36.

FIG. 4 shows the fixture 36. This fixture 36 is formed into a roughly rectangular parallelepiped, and a groove 36a in which the outer periphery of the optical fiber 28 is fixedly fitted is formed on a surface of the fixture 36 which is in contact with the base 32. The fixture 36 is fixed on the base 32 in a state in which the outer periphery of the optical fiber 28 is fitted onto the groove 36a, so that the optical fiber 28 can be fixed in a state in which the tension is maintained. For attachment of the fixture 36 on the base 32, various technique, such as by a screw, a glue, or the like, can be employed.

Thus, the end surface of the optical fiber 28 is constantly pressed against the mirror 34 by the tension of the optical fiber 28 by which the optical fiber is urged to return to its original state. Thus, the optical fiber 28 and the mirror 34 are optically connected efficiently in a simple configuration so that the optical transmission loss can be reduced.

By pouring matching oil or the like into a space between the end surface of the optical fiber 28 and the mirror 34, the transmission loss can be further reduced.

Further, the end surface of the optical fiber 28 can be glued to the mirror 34 by employing an optical glue or the like. Generally, in the case of gluing, although displacement, gap, or the like occurs due to a glue, since the optical fiber 28 is pressed against the mirror 34, such problem is eliminated. That is, the optical fiber 28 and the mirror 34 are in contact with each other firmly, and the loss between connections is reduced, whereby a stable laser output can be obtained.

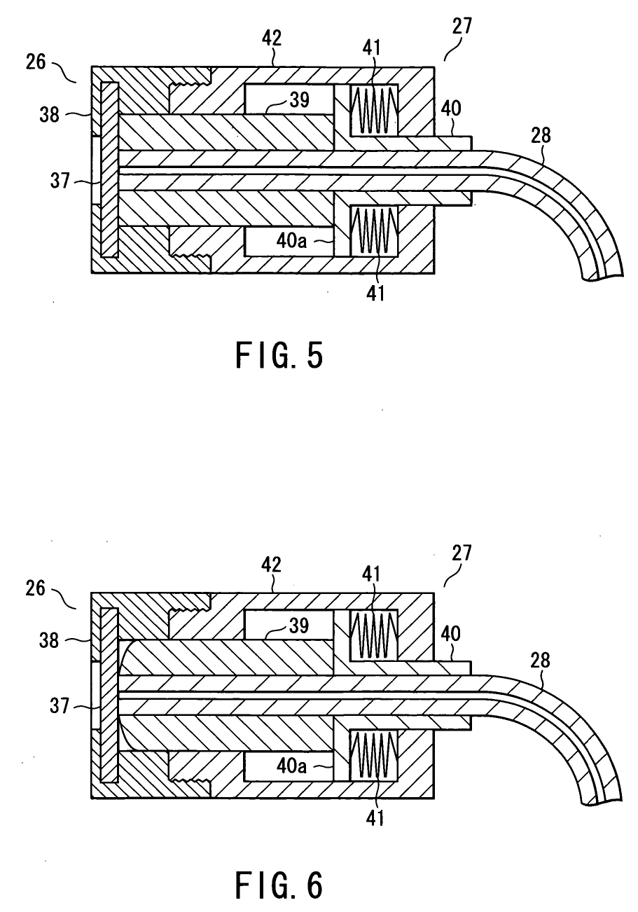

FIG. 5 shows a second embodiment of the present invention and shows another configuration of the mirror portion 26 and the fiber support portion 27. Explanation of the mirror portion 30 and the fiber support portion 29 will be omitted since they have a similar structure.

That is, the mirror portion 26 is composed of a mirror 37 formed into a disk-like shape and a cylindrical mirror support portion 38 which supports the peripheral portion of the mirror 37. This mirror 37 is, for example, one obtained by depositing a multilayer film on a thin flat glass and is arranged so that the deposition surface faces the optical fiber 28 side.

The optical fiber 28 is fixedly fitted into the fiber support portion 27, and the fiber support portion 27 comprises a cylindrical ferule 39 which is fabricated as a unit with the optical fiber 28. The end surface of one side of this ferule 39, together with the optical fiber 28, is polished so as to be flat. This ferule 39 can be loosely inserted into the mirror support portion 38.

The fiber support portion 27 is provided with a cylindrical pressing member 40 into which the optical fiber 28 is loosely inserted. A flange portion 40a is formed on one end of the pressing member 40. This flange portion 40a can come into contact with the other end surface of the ferule 39.

Further, the fiber support portion 27 accommodates a coil spring 41 between itself and the flange portion 40a of the pressing member 40 and is provided with a cylindrical ferule support portion 42 which is screwed into the mirror support portion 38.

The end surface of one side of the ferule 39, together with the optical fiber 28, comes into contact with the mirror 37 perpendicularly in a state in which the ferule support portion 42 is screwed into the mirror support portion 38. At this time the end surface of the one side of the ferule 39, together with the optical fiber 28, is pressed against the mirror 37 by a bias force of the spring 41 urged to stretch via the pressing member 40.

Although the above is described employing a spring, if pressing is possible, tightening may be performed employing screws or the like. In this case, it is necessary to provide a configuration in which a plurality of screw holes are drilled in the pressing member 40 so that ends of respective screws press the flange portion 40a.

Thus, similarly to the first embodiment, it is possible to optically connect the optical fiber 28 and the mirror 37 efficiently in a simple configuration so as to reduce the optical transmission loss. The ferule support portion 42 and the mirror support portion 38 may be fixed not only by screwing but also by means of a glue or the like.

FIG. 6 shows a third embodiment of the present invention, and the same reference numerals are assigned to the same parts as those of FIG. 5. In this embodiment, after the optical fiber 28 and the ferule 39 are fabricated as a unit, one end surface of the unit which comes into contact with the mirror 37 is polished so as to have a predetermined curvature.

That is, after the optical fiber 28 and the ferule 39 are fabricated as a unit, when the end surface which comes into contact with the mirror 37 is polished so that the surface becomes flat, there are cases in which the polished surface does not become perpendicular to the longitudinal direction of the optical fiber 28, whereby the polished surface has a certain angle.

In this case, even when the ferule 39 is arranged so as to be perpendicular to the mirror 37, since the polished surface has been polished so as to have a certain angle, an edge of the end surface of the ferule 39 comes into contact with the mirror 37 first, and a space is generated between the optical fiber 28 and the mirror 37, whereby transmission loss is produced.

On the other hand, when the end surfaces of the optical fiber 28 and the ferule 39 are polished so as to have a predetermined curvature, the distal end of the optical fiber 28 is always in contact with the mirror 37, and a bad influence due to an edge of the end surface of the ferule 39 can be prevented. Thus, the transmission loss can be reduced more in this method than in the method of flat polishing.

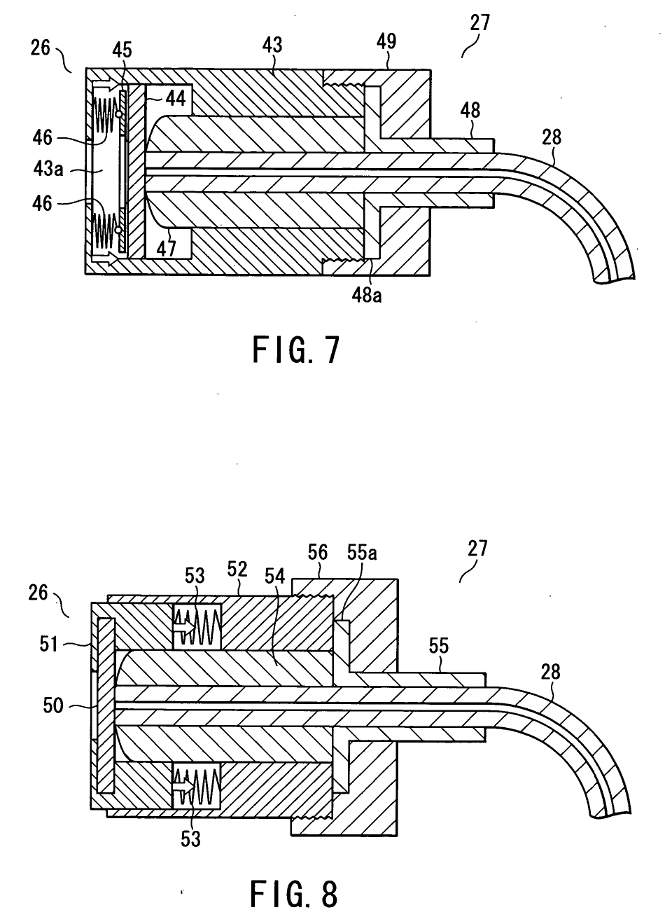

FIG. 7 shows a fourth embodiment of the present invention and shows another configuration of the mirror portion 26 and the fiber support portion 27. Explanation of the mirror portion 30 and the fiber support portion 29 will be omitted since they have a similar configuration.

That is, the mirror portion 26 is provided with a mirror support portion 43 formed into a cylindrical shape. An accommodating portion 43a accommodating a disk-like mirror 44 is formed in one end portion of the mirror support portion 43.

In this accommodating portion 43a, a bias force of a spring 46 is imparted to the surface of one side of the mirror 44 via a ring-like pressing plate 45 having a hole whose diameter is not smaller than the outer diameter of the optical fiber 28 so that the mirror 44 is biased in a direction toward an inner portion of the accommodating portion 43a, that is, the right direction in FIG. 7. Although the above is explained employing a spring, if pressing is possible, a rubber having an elasticity or the like may be employed. In the case where tightening is performed employing screws or the like, it is necessary to provide a configuration in which a plurality of screw holes are drilled in the mirror support portion 43 so that ends of respective screws press the pressing plate 45.

The fiber support portion 27 is provided with a cylindrical ferule 47 into which the optical fiber 28 is fitted and which is fabricated together with the optical fiber 28 as a unit. This ferule 47, together with the optical fiber 28, is polished so that the end surface of one side thereof has a predetermined curvature. This ferule 47 can be loosely inserted into the mirror support portion 43.

The fiber support portion 27 is provided with a cylindrical pressing member 48 into which the optical fiber 28 is loosely inserted. A flange portion 48a is formed on one end of the pressing member 48. This flange portion 48a can come into contact with the other end surface of the ferule 47. Further, the fiber support portion 27 is provided with a cylindrical ferule support portion 49 which engages the flange portion 48a of the pressing member 48 and which is screwed onto the mirror support portion 43.

When this ferule support portion 49 is screwed onto the mirror support portion 43 so that the end surface of the optical fiber 28 comes into contact with the mirror 44 and so that the mirror 44 is moved against the bias force of the spring 46, the end surface of the optical fiber 28 is pressed against the mirror 44.

Thus, similarly to the above-described respective embodiments, it is possible to optically connect the optical fiber 28 and the mirror 44 efficiently in a simple configuration so as to reduce the optical transmission loss. The ferule support portion 49 and the mirror support portion 43 may be fixed not only by screwing but also by means of a glue or the like. The end surfaces of the ferule 47 and the optical fiber 28 which have been fabricated as a unit may be given flat polishing.

FIG. 8 shows a fifth embodiment of the present invention and shows another configuration of the mirror portion 26 and the fiber support portion 27. Explanation of the mirror portion 30 and the fiber support portion 29 will be omitted since they have a similar configuration.

That is, the mirror portion 26 is composed of a mirror 50 formed into a disk-like shape, a cylindrical mirror support portion 51 supporting the peripheral portion of this mirror 50, and a holder 52 slidably holding the mirror support portion 51 along the axial direction thereof. A bias force is applied to the mirror support portion 51 and the holder 52 in directions in which they pull against each other by a spring 53 which is attached between them.

The fiber support portion 27 is provided with a cylindrical ferule 54 into which the optical fiber 28 is fitted and which is fabricated as a unit with the optical fiber 28. The end surface of one side of this ferule 54, together with the optical fiber 28, is polished so as to have a predetermined curvature. This ferule 54 can be loosely inserted into the mirror support portion 51 and the holder 52.

The fiber support portion 27 is equipped with a cylindrical pressing member 55 into which the optical fiber 28 is loosely inserted. A flange portion 55a is formed on one end of the pressing member 55. This flange portion 55a can come into contact with the other side end surface of the ferule 54. Further, the fiber support portion 27 is provided with a cylindrical ferule support portion 56 which engages the flange portion 55a of the pressing member 55 and which is screwed onto the holder 52.

When this ferule support portion 56 is screwed onto the holder 52 so that the end surface of the optical fiber 28 comes into contact with the mirror 50 to further permit the mirror 50 to move against the bias force of the spring 53, the end surface of the optical fiber 28 is pressed against the mirror 50.

Thus, similarly to the above-described respective embodiments, it is possible to optically connect the optical fiber 28 and the mirror 50 efficiently in a simple structure so as to reduce the optical transmission loss. The ferule support portion 56 and the holder 52 may be fixed not only by screwing but also by means of a glue or the like. The end surface of the ferule 54 and the optical fiber 28 which have been fabricated as a unit may be given flat polishing.

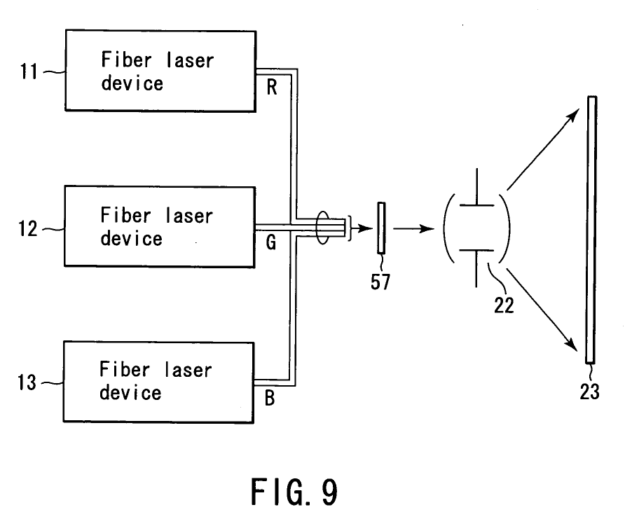

FIG. 9 shows another example of a liquid crystal projection TV receiver. In FIG. 9, the same referential numerals are assigned to the same parts as those of FIG. 1. In explanation for the drawing, generated is white light in a case where R, G, B lights obtained from the respective fiber laser devices 11, 12, 13 are collected into one and are seen macroscopically (entirely).

This white light is incident onto a liquid crystal panel 57 having a color filter, and after spatial modulation by a video signal is given to the white light, the white light is enlarged and projected on the screen 23 via the projection lens 22.

It is needless to say that any fiber laser device shown in FIGS. 3 to 8 may be employed in the fiber laser devices 11, 12, 13.

With the video display apparatus shown in FIGS. 1 to 9, by bringing mirrors and an optical fiber, as a fiber laser device for a commercial display use, to a state in which they are constantly pressed by a certain force, the mirrors and the optical fiber are firmly in contact with each other, whereby it is possible to reduce a loss between connections and to obtain a stable laser output.

The present invention is not limited to the above-described respective embodiments as they are and can be embodied by variously modifying constituent elements within the scope of the present invention without departing from the spirit of the invention at a stage when it is put into practice. By appropriately combining a plurality of constituent elements disclosed in the above-described respective embodiments, various inventions can be formed. For example, some constituent elements may be deleted from all of the constituent elements shown in the embodiments. Further, constituent elements according to different embodiments may be combined appropriately.

What is claimed is:

1. A laser output device comprising:
an optical fiber;
a mirror configured to reflect light of a specific wavelength transmitting in the optical fiber to return the light to the optical fiber; and
a support portion configured to support an end surface of the optical fiber and the mirror in a state in which they are pressed against each other.

2. A laser output device according to claim 1, wherein the support portion fixes the optical fiber in such a way that tension which permits the end surface of the optical fiber to be pressed against the mirror is generated in the optical fiber itself in a state in which the end surface of the optical fiber is in contact with the mirror.

3. A laser output device according to claim 1, wherein a laser active material is added to the optical fiber, and the mirror is a resonant mirror of an upconversion fiber laser in which the optical fiber to which the laser active material is added is excited by employing laser light.

4. A laser output device according to claim 1, wherein the optical fiber is fixed in a ferule, and an end surface of the ferule, together with the optical fiber, is polished.

5. A laser output device according to claim 1, wherein the optical fiber is fixed in a ferule, and an end surface of the ferule, together with the optical fiber, is polished so as to have a predetermined curvature.

6. A laser output device according to claim 4 or 5, wherein the support portion presses the end surface of the optical fiber against the mirror by a bias force of a spring which is applied to the ferule.

7. A laser output device according to claim 1, wherein the support portion presses the mirror against the end surface of the optical fiber by a bias force of a spring which is applied to the mirror.

8. A laser output device according to claim 1, further comprising a modulation portion configured to perform spatial modulation for the light excited by the optical fiber based on a video signal.

9. A laser output method comprising:
supporting an end surface of an optical fiber and a mirror which reflects light of a specific wavelength transmitting in the optical fiber to return the light to the optical fiber in a state in which the end surface of the optical fiber and the mirror are pressed against each other.

10. A laser output method according to claim 9, further comprising:
performing spatial modulation for the light excited by the optical fiber based on a video signal.

11. A video display apparatus comprising:
a fiber laser device configured to support an end surface of an optical fiber and a mirror which reflects light of a specific wavelength transmitting in the optical fiber to return the light to the optical fiber in a state in which the end surface of the optical fiber and the mirror are pressed against each other;
a modulation portion configured to perform spatial modulation for the light to be outputted from the fiber laser device based on a video signal; and
a display portion configured to project and display light output obtained from the modulation section on a screen.

12. A video display apparatus according to claim 11, wherein the fiber laser devices and the modulation portions are disposed corresponding to R, G, B lights, respectively, and the display portion synthesizes light outputs from the respective modulation sections corresponding to the R, G, B lights to project synthesized light on the screen.

13. A video display apparatus according to claim 11, wherein the fiber laser devices are disposed corresponding to R, G, B lights, respectively, and the modulation portion performs spatial modulation for white light obtained by collecting output lights of the respective optical fibers corresponding to the R, G, B lights.
